(19) United States
(12) Patent Application Publication
(10) Pub. No.: US 2019/0336250 A1
(43) Pub. Date: Nov. 7, 2019

(54) DENTAL IMPLANT

(71) Applicant: Nikita Sergeevich CHERNOVOL, Sankt-Peterburg (RU)

(72) Inventor: Nikita Sergeevich CHERNOVOL, Sankt-Peterburg (RU)

(21) Appl. No.: 16/349,779

(22) PCT Filed: Apr. 6, 2017
(86) PCT No.: PCT/RU2017/000207

§ 371 Date: May 14, 2019

(30) Foreign Application Priority Data
Jan. 27, 2017 (RU) 2017102870

(51) Int. Cl. A61C 8/00

(52) U.S. Cl. CPC A61C 8/0069; A61C 8/0066; A61C 8/0068

(57) ABSTRACT

The invention relates to surgical and orthopedic dentistry, particularly to implantology, more particularly to apparatus for mounting a dental prosthesis at the site of a missing tooth, and more particularly to dental (tooth) implants. Proposed is an implant which consists of a base section, an abutment and a connecting screw, said abutment having a conical surface with a total angle of 7°-9°, and lobes positioned in the inner gingival region, and said screw being threaded with a pitch of 0.2±0.05 mm. The implant has enhanced strength, particularly when in the form of narrow prostheses.

### CROSS-REFERENCE TO RELATED APPLICATIONS

The present application is National stage application from PCT application PCT/RU2017/000207 filed Apr. 6, 2017 which claims priority to Russian patent application RU2017102870 filed Jan. 27, 2017.

### FIELD OF THE INVENTION

The invention relates to surgical and orthopedic dentistry, in particular to implantology, namely to the devices for delivering a denture instead of a lost tooth, precisely to dental implants.

### BACKGROUND OF THE INVENTION

Dental implant is fixed either directly into the tooth socket or after its healing (delayed implantation). In the first case, a part of the implant at the survival stage will be in soft tissues. After fixing a dental implant, its surface should and will osteointegrate inside the jaw bone. If, after the implant insertion, primary stability is insufficient or the patient has such risk factors as diabetes, smoking, etc., then it is preferable to place the implant using a two-stage method with closed healing, and to place the implant after osteointegration.

The implant can be single-component or consist of two or more components. In case of delayed implantation, as a rule, a two-component implant is used, thereby enabling to close the soft tissues over the implant for the time required for healing.

The exterior design of most implants resembles a screw. This screw is threaded into the upper or lower jaw after preparation of the implant site. In most cases, such a dental implant consists of a base part fixed in the bony tissue of the jaw, an abutment on which the crown is mounted, and a retaining screw connecting the abutment and the base part.

Both the base part and the abutment are usually made of metal or ceramic, in particular, titanium, zirconium, titanium alloy, zirconium alloy, titaniferous alloy, zirconiferous alloy, ceramic of zirconium and aluminum oxides. In addition, ceramics made of silicon or silicon oxide and containing, for example, nitrogen, hydrogen, carbon or tungsten, can be used.

The structure of dental implants and the peculiarities of their components preparation are covered by several hundred patents from different countries (RU 2602678, 2016; RU 2567596, 2014; RU 2485910, 2012; US 2005/0287497, 2005; WO 03020154, 2003. DE 10315399, 2004; EP 1728486, 2006; WO 97/20518,1997; WO 96/29020, 1996 and etc.).

In particular, in accordance with the information contained in the patents, the base part is usually made in the form of a suitably molded metal body, which consists of intraosseous and extraosseous parts and has at its coronal end a receiving hole into which the abutment is inserted. (The term “coronal” in this case and hereinafter is understood as the direction towards the crown or the tooth being set, and “cervical” means the direction towards the tooth root). At the cervical end, the base part from the outside is threaded for fixing the implant in a suitably prepared bed in the jaw bone. The thread can be self-driving and not self-driving. The thread provided for in the outer area of the base part is usually designed for high primary stability of the system and for uniform transmission of forces arising from the mastication load on the dental implant, the jaw bone, but its design does not always solve this problem. Thus, an implant is currently in use which base part has an external thread with a thread pitch of about 0.6 mm (U.S. Pat. No. 5,588,838, 1996). This design does not allow for reliable fixation of the implant in the cancellous bone and is not able to withstand early mastication loads, due to the low profile and small thread pitch on the base part. Dental prosthetics using this design may be carried out 3-6 months after its placement, which delays the treatment time.

The abutment, which can be placed in the receiving hole of the base part, has a surface for direct or indirect placement of an orthopedic restoration (for example, a crown) and a connecting area for the connection with the implant, which can usually be inserted into the above-mentioned receiving hole of the implant. The abutment connecting area has a conical section with a certain cone length, to which an index section with a certain index length adjoins in the cervical direction.

The connecting area of the abutment and the corresponding adjoined inner surface of the implant base part provides improved mechanical joint of elements and contributes to the formation of a tight seal to avoid the formation of a gap in which fluid or bacteria can accumulate.

However, such conical structures have several disadvantages. In particular, during the subsequent molding of the implant, a shift in height may occur due to the cone angle and diameter tolerances.

Usually, an index area is located on the abutment surface designed to ensure reliable rotation or positioning of the abutment and the base part of the implant during the implant assembly process and, at the same time, as the approach surface for the engaging instrument. Such index areas peripherally form a geometric closure with a non-circular contour, for example, made in the shape of a polyhedron or oval (RU 2273464, 2006; RU 2485910, 2013) or by means of grooves and cams.

The first direction is not widely spread due to technological difficulties in the manufacture of the base part and the abutment of abnormal shape in conditions of relatively thin walls of the base part of the implant and the increasing possibility of leakage of their joint. Using a cam and groove system is more common.

It is important to choose the base part-abutment joint, which should be sufficiently durable, because it transmits the load from the orthopedic restoration to the osteointegrated basic part of the implant. It can support the implant structure and prevent fractures or weakening of all the components of dental implant restorations.

Previously, a connecting pin was used in such joints, which protruded above the base part of the implant, and the connecting part on the abutment was designed to be set on the connecting pin. In this case, the joint of these parts was carried out using a screw.

The disadvantage of this joint was the lack of structural strength due to the possibility of breaking the pin and technical difficulties in case of its replacement. Therefore, in modern devices, the connecting pins were transferred to abutments, and the joint area was inside the base part of the implant. And, the joint in these structures is mainly located inside the implant and is conical, and there are guides to prevent rotation of the abutment, and the surface of the abutment joint is tilted inside the implant. The abutment in the cervical direction, adjacent to the index section at the cervical end, has an end surface with a hole. Through this hole, the abutment is connected to the base part by means of a specially selected fixing (retaining) screw. At the same time, a threaded section of the retaining screw is inserted through the aforementioned abutment hole, which is further screwed into the corresponding internal thread of the base part. As a result, the screw head presses the abutment to the base part. The screw length and, in particular, the location of the thread thereon, are chosen in such a way that the abutment screw cannot be engaged with the threaded section in the implant until the abutment with the end surface of its cam on the cervical end is set on the implant platform. Thereby, the erroneous fixing of the abutment in the implant by tightening the abutment screw before it reaches the desired position is prevented.

In technical essence, a dental implant (RU 2567596, 2015) is the closest to the claimed solution, which contains a base part with a receiving hole for abutment at the coronal end, and the receiving hole in the direction from the coronal end has a conical section with a total cone angle of 6° to 20°, preferably 15°, and the index section of a cylindrical shape, forming a guide surface for the mounted abutment. On the cylindrical section of the base part there is at least one groove extending radially outwards, and on the cylindrical section of the abutment there is the same number of cams, while the grooves are adapted to engage with the corresponding abutment cam and having an outer diameter that is smaller or equal to the minimum diameter of the conical section. In the cervical direction of the base part, the threaded section for the retaining screw is directly adjacent to the index section.

The disadvantage of this device is the technological complexity of manufacturing the base part and the abutment with varying surface geometry, insufficient strength of the abutment in the beginning of the index area, as well as the need to thin the walls of the base part body for a narrow implant when placing an abutment with cams in the intragingival implant area due to the need to use a conical surface with large total angles

The problem solved by the author was the creation of an operationally reliable device when making and using narrow implants.

### SUMMARY

The basis of the claimed invention is the proposed modification of the joint between the base part of the implant and the abutment. The importance of this area is determined by the fact that the implant-abutment joint causes the abutment to be fixed in the correct position in the patient's mouth, before the orthopedic restoration (eg, a crown) made in the dental laboratory will be mounted on the abutment, and is used, as a rule, to transmit torque from the implant seating instrument to the implant when placing the implant in the patient's jaw.

This area consists of guides and a fixing screw. As a rule, the fixing screws used in the joints between the abutment and the base part have a thread pitch of 0.2-0.5 mm per revolution. The sufficient reliable anchoring of the abutment is achieved by a certain number of working thread pitches, and the thread works only with favorable twisting) (<90°), at which self-centering functions due to the pressing force of the fixing screw when tightening it between the abutment and the base part. Assuming that three or four thread pitches should be working, the height of the abutment in the base part should be 0.6 mm or more, which “squeezes out” the indicated joint from the intragingival area, increasing the likelihood of the denture fracture and/or making the cervical end of the abutment thinner than the cone.

To solve this problem, the author proposes to reduce the thread pitch of the fixing screw to 0.2±0.05 mm and make the cams on the conical surface of the abutment so that the joint is in the intragingival area of the jaw. In this case, the total angle of the conical surface is from 5° to 9°, optimally 7°.

The abutment has a conical surface on the index section, from which at least one cam extends radially outward, adapted to engage with the corresponding grooves of the implant. The surface is designed and has such tolerances to form a guide surface for the surface of the index section of the implant when the abutment is inserted in the implant.

Optimally, the abutment has three cams, and the base part of the implant has three guides inside the cone of the base part of the implant. The best results are achieved if

one of the cams and the corresponding guide are larger than the others. In this case, an unambiguous, predetermined position of the abutment against the base part is ensured. As a result, when inserted in the base part in a simple and mechanically stable manner, a reliable orientation of the correspondingly prepared abutment with a denture, is achieved. Thus, the duration of treatment of the patient when inserting the abutment in the oral cavity can be significantly reduced, and yet a very high quality orientation of the denture is provided.

The index areas of the base part of the implant and the abutment, as well as the conical parts of the implant and the abutment are designed and formed in such a way that when the abutment is inserted in the implant, the conical parts are at least partially in contact with each other, and the index areas are engaged with each other. Due to the contact between the conical areas in the area of the coronal edge, an especially stable abutment anchorage in the implant is achieved. There is a somewhat two-position anchorage, on the one side, on the upper coronal edge, and on the other side, in the area of the guiding surfaces between the grooves or cams.

The attributes of the claimed invention in comparison with prior art is the joint of the abutment and the base part of the implant, in particular for a narrow implant. Their importance is due to the fact that when using implants to eliminate single defects in a small bone areas, it is possible either to perform augmentation and to place a stronger implant, or to place a small-diameter implant without augmentation, which is preferable for the patient. However, when using small-diameter implants, the risk of fracture of the implant components increases some time after the functional load.

To prevent the risk of fracture of the implant components this invention uses narrow but very strong implants with a diameter of 3.4-3.8 mm.

In prior art the narrow hardening implants are made with thick implant walls or thick abutment walls. Some of them have a flat or conical joint, as shown in FIG. 2. Inside the conical joints, the guides are mainly located under the cone, since the conical section provides a sealing effect. This means that within narrow implants the cone length is limited and in most cases not sufficient.

Another option is a long cone, but narrow guides. However, if the guides are narrow, then the torque used to place the implant will be limited, and the rotational tolerance between the implant and the abutment will be large. This in both cases leads to an implant strength reduction.

An important element influencing the joint strength is the fixing screw and its preload after fixation. The more the preload, the better and stronger the joint will be. But if the preload is too high, it will increase the risk of fractures. However, to ensure that the screw is as strong as possible, the diameter of the screw core will be as high as possible. However, if the screw diameter is too high, then the thickness of the abutment and the implant walls will need to be reduced, which will increase the risk of fractures when the implants are loaded. In the invention it is proposed to leave the diameter of the screw core unchanged, but at the same time to reduce the external diameter of the screw due to a significant reduction in the thread pitch.

Usually for narrow implants, an M1.6 thread with a 0.35 mm pitch is used. In order to maintain the diameter of the screw core and reduce the nominal diameter of the screw, which would ensure an increase in the implant, an innovative approach can be used in which the thread pitch should be reduced to 0.2±0.025 mm. This will allow to obtain an external diameter of 1.4 mm with the same core diameter as that of a screw with a diameter of 1.6 mm and a thread pitch of 0.35 mm. It was found that for an implant with an external diameter of 3.5-3.8 mm, the strongest combination of sizes for abutments is when the external diameter of the abutment is 2.8 mm in the implant shoulder (FIG. 2) area, where the abutment coining out of the implant. This allowed the use of a long cone with guides in the middle, ensuring the perfect transfer of load from the abutment to the implant. In this case, the abutment inside will include the upper conical area and the lower conical area, which will be below the area of the guides. As a result, the abutment will stabilize above and below the guides inside the implant when it is loaded under the influence of surcharge axial loads. This will provide the small guides and a long conical joint thereby ensuring the conditions for the strength of a narrow implant. The cone angles used inside the implant-abutment joint are of 5°-9°, which ensures, in these conditions, as the studies have shown, the highest joint strength.

### BRIEF DESCRIPTION OF DRAWING FIGURES

The invention is explained further in more detail on the basis of embodiments and drawings:

FIG. 1 presents the typical design of a dental implant (1) including the base part of the implant (2) and the abutment (3) assembled.

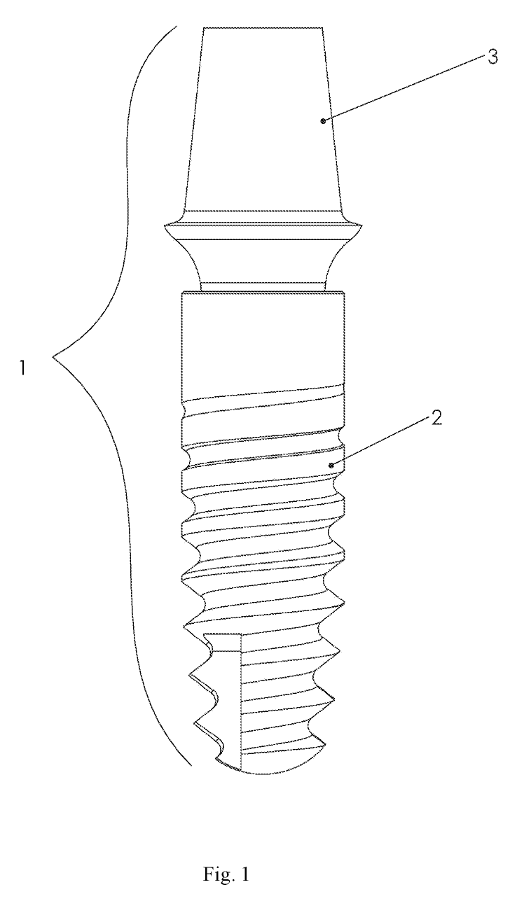

FIG. 2 presents the cross-section of the dental implant shown in FIG. 1, which also has a fixing (retaining) screw (4).

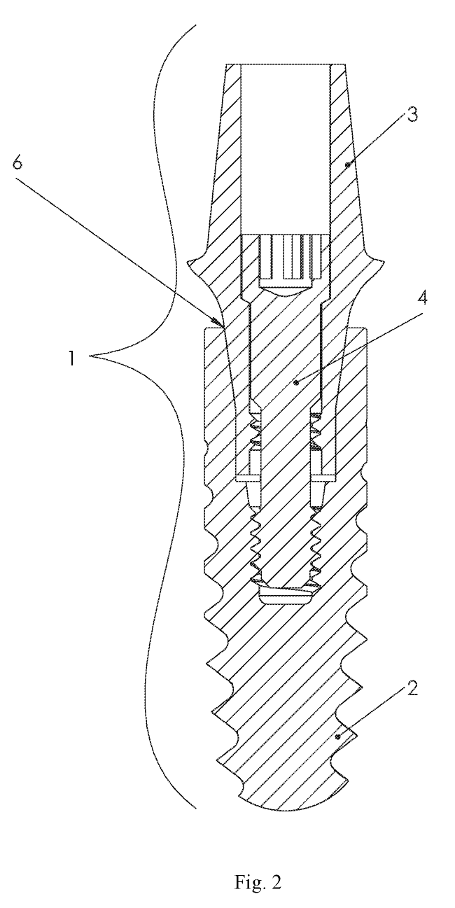

FIG. 3 shows an implant (2) with an external thread (22) and an internal fixation (5). Internal fixation (5) shows a conical section 55, an area with guides (555) and an internal thread (5555). The conical area (55) is located above the area with guides (555) and the thread area (5555).

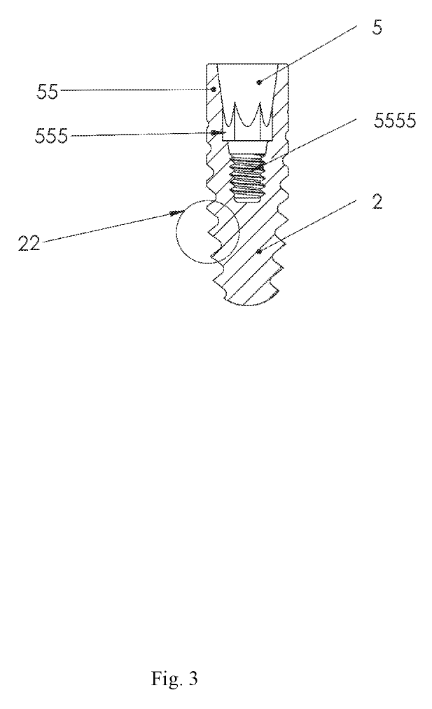

FIG. 4 shows an abutment (3) which has a conical contact pin (33) and a guide area (333). Inner hole (3333) for fixing the retaining screw inside the implant.

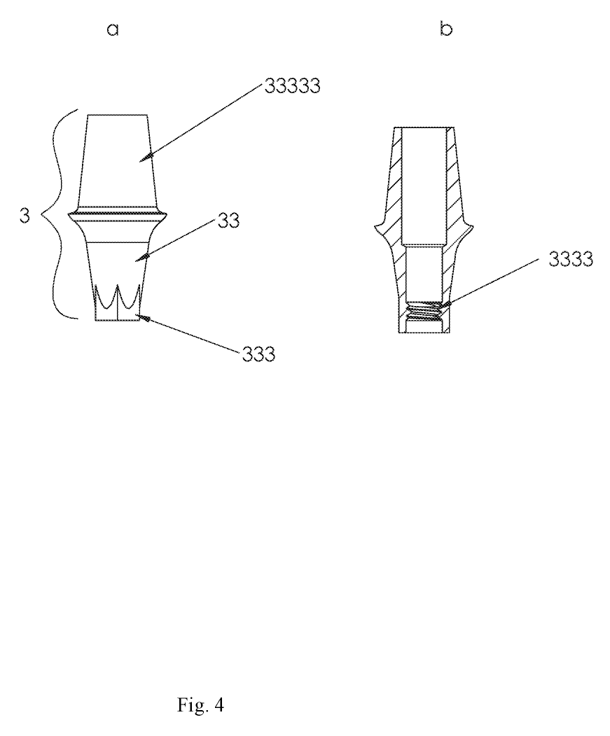

Orthopedic components (such as crowns or bridges) are mounted above the upper contact pin (33333).

FIG. 5 shows the abutment scheme for different sizes of guide grooves, which has a conical contact pin (33) and a guide area (333). Inner hole (3333) for fixing the retaining screw inside the implant, the abutment (3) inside includes the upper conical area (33a) and the lower conical area (33b), which will be below the guide area (333)

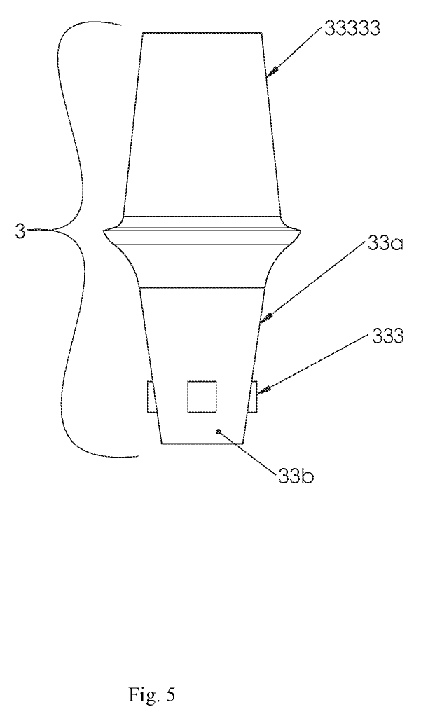

FIG. 6 shows a comparison of these two threading options. Screw 4a—a standard screw with thread 444a M1.6, core diameter 44a and thread pitch 0.35. The screw 4b has the same core diameter of 44b as 4a with the core diameter of 44a.

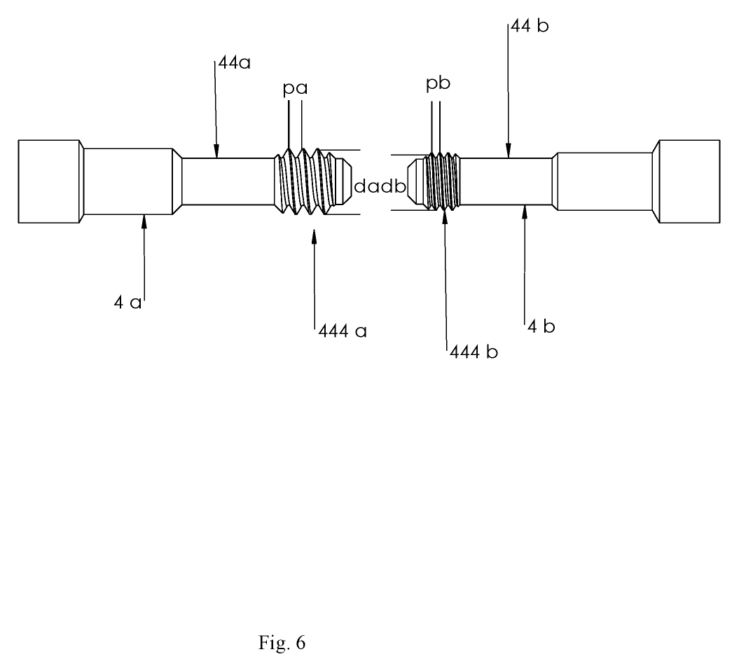

FIG. 7—top view of the base part of the implant (2). Inside the cone three guides are shown. In FIG. 7a—guides 7 and 77 of the same size. In FIG. 7b—two guides 7 of the same size and one guide 77 of the larger size.

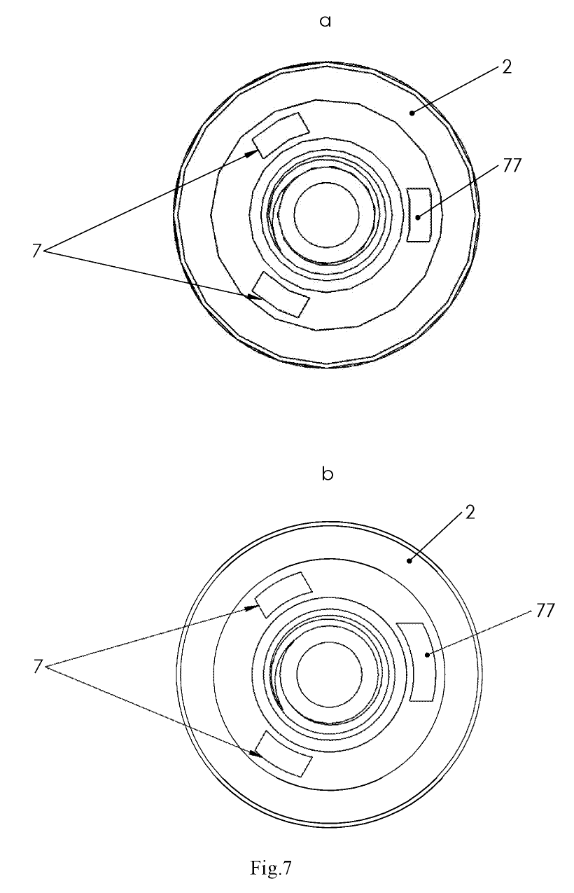

### DETAILED DESCRIPTION OF THE PREFERRED EMBODIMENT

The device works as follows. To place the dental implant 1 in the patient's mouth, at the first stage of treatment, it is provided that the base part 2 is mounted in the jaw bone. For this, the base part 2 has a thread 22 on the outside, made as a self-driving thread, so that the placement in the jawbone can be done by screwing in. In this case, the thread 22 pitch can be made uniform or variable, and due to the appropriate choice of parameters, possible various biological factors, etc., as well as different types of implantation can be taken into account. In this case, the design and parameters of the thread 22 are calculated, in particular, taking into account the desired high primary stability and uniform transmission of forces arising from the mastication load of the dental implant to the jaw bone. In combination with a properly formed cone, a self-holding joint is detected when the abutment is inserted into the implant. Thereby, additional stability of the joint is achieved.

After insertion of the base part 2, an implantation phase of four weeks to six months is provided in the jawbone, during which the base part should grow into the tissue and jaw bone.

Then, at the second stage of treatment, an abutment 3 with the denture element can be inserted. With particularly favorable bone behavior and consequently high primary stability, the abutment 3 and other prosthetic components can be placed even immediately after the insertion of the base part or implant. To mechanically establish a relatively stable joint between the base part 2 and the abutment 3, on the abutment 3 a contact pin 33 is made, which, when the base part 2 is assembled with the abutment 3, is inserted into a notch in the base part 2, forming a receiving channel for the retaining screw 4. The mechanical joint of the base part 2 with the abutment 3 is carried out by means of the corresponding fixing screw 4, with the external thread 444 screwed into the internal thread 5555 provided in the base part 2. In this case, the head of the fixing screw 4 presses the abutment 3 to the base part 2.

What is claimed is:

1. A dental implant for placement in a jaw bone, comprising a base part, an abutment and a fixing screw, with an abutment receiving hole located at a coronal end of the base part of the implant, having a conical index section in a direction from the coronal end, forming a guide surface for the abutment, and at least one groove is extending radially outwards and arranged in the guide surface, designed to engage with an abutment cam, and in a cervical direction a threaded section is immediately adjacent to an index section for inserting the fixing screw; the abutment contains a connecting area for connection with the base part of the implant having a conical section adjacent by an index section in a cervical direction so that it forms a guide surface for the surface of the index section of the base part of the implant when the abutment is inserted in the implant, and at least one cam is radially moving away, designed to engage with the corresponding grooves of the base part of the implant, and the cervical end has an end surface with a hole through which the threaded section of the fixing screw can be inserted; while the index sections and the conical sections of the base part of the implant and the abutment are formed in such a way that, with the inserted abutment, the conical areas are at least partially in contact with each other, and the index areas are engaged with each other, and in each pair of the base part of the implant and the corresponding abutment there is a contact between the conical areas adjacent to an coronal end edge of the base part of the implant, and the fixing screw is designed not to engage with the threaded section of the base part of the implant, if the abutment with its end surface of the cam in an intermediate position lies on a surface of a platform of the base part of the implant, wherein the fixing screw has a thread pitch of 0.2±0.05 mm, and the cams are made on the conic surface of the abutment so that the connection is in an intra-gingival area of the jaw.

2. The dental implant according to claim 1, wherein that if there are three guides inside the conical section of the base part of the implant, one of them is made larger than the other two.

3. The dental implant according to claim 1, wherein a total angle of the conical surface is 5°-9°.

4. The dental implant according to claim 3, characterized in that the total angle of the conical surface is 7°.
